(19) United States
(12) Patent Application Publication
(10) Pub. No.: US 2013/0155733 A1
(43) Pub. Date: Jun. 20, 2013

(54) GENERATING A FAST RESET-SIGNAL USING A FAULT-PROTECTION LATCH

(71) Applicant: Robert Mayell, Los Altos, CA (US)

(72) Inventor: Robert Mayell, Los Altos, CA (US)

(73) Assignee: Power Integrations, Inc., San Jose, CA (US)

(21) Appl. No.: 13/332,256

(22) Filed: Dec. 20, 2011

(51) Int. Cl. H02H 7/125; H02H 3/24

(52) U.S. Cl. 363/52; 361/92

(57) ABSTRACT

Methods and apparatuses are disclosed for monitoring an ac input for fault conditions. The ac input may be monitored by a latch-reset that uses the ac input to charge a line detection capacitor. The latch-reset may be configured such that the voltage at one end of the line detection capacitor drops below a line detection threshold voltage when the ac input is removed for longer than an allowable period of time or if the voltage of the ac input falls below an acceptable value. The drop in voltage at the end of the capacitor may cause an electrically coupled transistor to switch, thereby causing a reset-signal to be generated.

### BACKGROUND

1. Field

The present disclosure relates generally to power converters and, more specifically, the present disclosure relates to detecting fault conditions in a power converter using a fault-protection latch-reset.

2. Related Art

Power converters are used in many electrical devices to transform an alternating current (ac) power supply into a direct current (dc) power supply. Generally, these converters include a controller that switches a power switch between an ON state and an OFF state to control the amount of power transmitted to the output of the converter.

Some power converter controllers may include fault-protection circuitry that detect and respond to fault conditions of the controller and/or power supply (e.g., over voltage condition, low voltage condition, and the like). In some instances, the fault protection circuitry may cause the controller to shut down the power converter. In this scenario the power converter may use an input monitoring circuit to indicate resetting of the controller when input to the power converter has been removed (e.g., due to the converter being unplugged from a wall outlet). Specifically, when the ac input is removed the input monitoring circuit may provide a reset signal to reset the controller back to its initial conditions such that when the power converter is again connected to the ac input, the controller may presume operation.

Conventional input monitoring circuits generally include resistive elements (e.g., 2M-ohm resistors) connected to the AC input of the power converter that continuously dissipate power. While these circuits are effective at detecting fault conditions, the resistive elements cause the power converter to consume relatively large amounts of power at no-load conditions. For example, some conventional input monitoring circuits consume power during normal operation. While the amount of power consumed may be small relative to the amount of power delivered to an attached load, it may be a relatively large portion of power to consume during no-load conditions.

Additionally, specifications for newer electronic devices require that power converters consume less power during no-load conditions. For example, some laptop specifications require that the total no-load consumption of an adapter be less than 30 mW. However, conventional input monitoring circuits may consume 30 mW or more alone, leaving no room for power consumption by the rest of the power converter.

### BRIEF DESCRIPTION OF THE FIGURES

Non-limiting and non-exhaustive embodiments of the present invention are described with reference to the following figures, wherein like reference numerals refer to like parts throughout the various views unless otherwise specified.

FIG. 1 is a functional block diagram illustrating an example power converter including a fast ac latch-reset, in accordance with an embodiment of the present invention.

FIG. 2 is a circuit diagram illustrating an example ac latch-reset, in accordance with an embodiment of the present invention.

FIG. 3 illustrates example waveforms of an ac latch-reset, in accordance with an embodiment of the present invention.

FIG. 4 is a circuit diagram illustrating another example ac latch-reset, in accordance with an embodiment of the present invention.

FIG. 5 is a circuit diagram illustrating another example ac latch-reset, in accordance with an embodiment of the present invention.

FIG. 6 illustrates example waveforms of an ac latch-reset, in accordance with an embodiment of the present invention.

FIG. 7 illustrates an example process for detecting a fault condition at the ac input of a power converter, in accordance with an embodiment of the present invention.

FIG. 8 illustrates examples waveforms of an ac latch-reset, in accordance with an embodiment of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

In the various embodiments, an ac input may be monitored by an input monitoring circuit that uses the ac input to charge a line detection capacitor. The input monitoring circuit may be configured such that the voltage at one end of the line detection capacitor drops below a line detection threshold voltage when the ac input is removed for longer than an allowable period of time or when the voltage of the ac input falls below an acceptable value. The drop in voltage at the end of the capacitor may cause an electrically coupled transistor to turn on, thereby causing a reset-signal to be generated.

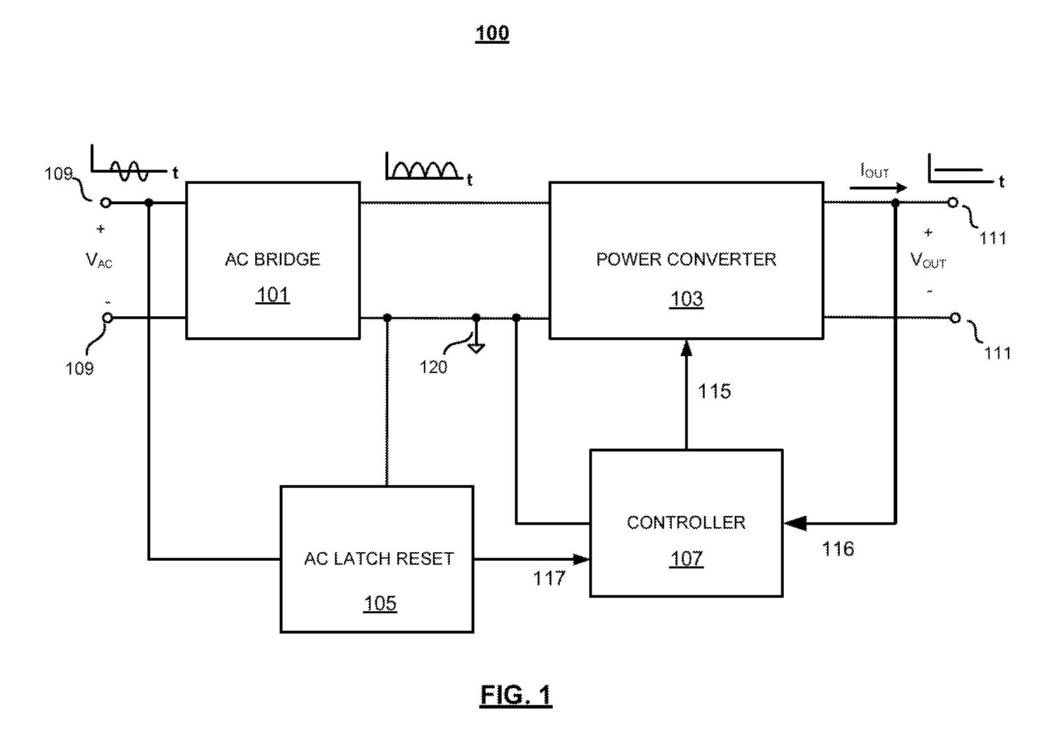

To illustrate, FIG. 1 is a functional block diagram illustrating an example power converter system 100. In the illustrated example, power converter system 100 includes AC Bridge 101, power converter 103, AC-latch-reset 105, and controller 107. Power converter system 100 may be configured to, or be operable to, receive ac input voltage V_{AC} at input terminals 109 and output dc output voltage V_{OUT} at output terminals 111. As shown in FIG. 1, power converter system 100 includes AC Bridge 101 coupled to the input terminals 109 of the device. AC Bridge 101 may be configured to receive and rectify ac input voltage V_{AC} to generate a rectified (dc) voltage. More specifically, a rectified or dc voltage may be defined as having one polarity, whereas an ac voltage may be defined as having both a positive and negative polarity. In other words, a rectified (dc) voltage is a time-varying dc voltage. AC Bridge 101 may include any rectification circuit known to those of ordinary skill in the art. In some examples, AC Bridge 101 may include four diodes (not shown) arranged as a diode bridge. AC Bridge 101 may further include other circuit elements that one skilled in the art would know how to arrange for a particular application.

Power converter system 100 further includes power converter 103 coupled to the output of AC Bridge 101. Power converter 103 may be configured to receive a rectified voltage and output dc output voltage V_{OUT}. Power converter 103 may include many types of power converter topologies such as, but not limited to, flyback, forward, buck, and boost topologies. In addition, power converter 103 may further include a power switch (not shown) that switches to control the transfer of energy through a magnetic energy transfer element (not shown). In one example, power converter 103 may include a coupled inductor (not shown) electrically coupled to a power switch, such as, but not limited to, a metal oxide semiconductor field effect transistor (MOSFET). The power switch may be used to control the amount of current conducted through the coupled inductor, and thus, the amount of power transferred to the output winding (not shown) of the coupled inductor, by switching between an ON state (allowing current to be conducted through the switch) and an OFF state (preventing current from being conducted through the switch). Power converter 103 may further include capacitors, such as an input-smoothing capacitor (not shown), an output-smoothing capacitor (not shown), clamp circuitry (not shown), feedback circuitry (not shown), or other circuit elements that one skilled in the art would know how to arrange for a particular application.

Power converter system 100 further includes controller 107 for controlling the output voltage V_{OUT} at output terminals 111 by selectively scheduling the switching events of power converter 103. In one example, power converter system 100 may regulate an output current and/or a combination of output voltage V_{OUT} and output current I_{OUT}. Specifically, controller 107 may be configured to initiate a switching event by sending a drive signal 115 to the base or control terminal of the power switch in power converter 103. Controller 107 may adjust characteristics of the switching events (e.g., frequency, duration, etc.) to control the amount of power delivered to the output of power converter system 100. Additionally, in response to a fault condition at the input of power converter system 100 (e.g., as indicated by a reset signal 117), controller 107 may be configured to shut down or enter a protection-mode in which the controller inhibits switching of the power switch, except when periodically attempting to restart the system.

As shown, controller 107 may receive a feedback signal 116 representative of information relating to the output of power converter system 100. For example, controller 107 may receive feedback signal 116 in order to regulate output voltage V_{OUT} at output terminals 111. In one example, controller 107 may be implemented as an integrated circuit. In another example, controller 107 and the power switch in power converter 103 may form part of an integrated control circuit that is manufactured as either a hybrid or monolithic integrated circuit.

Power converter system 100 further includes AC-latch-reset 105 for detecting fault conditions (e.g., removal of the AC input or low voltage condition) at the input of power converter system 100 and generating a reset signal 117 in response to detecting a fault condition.

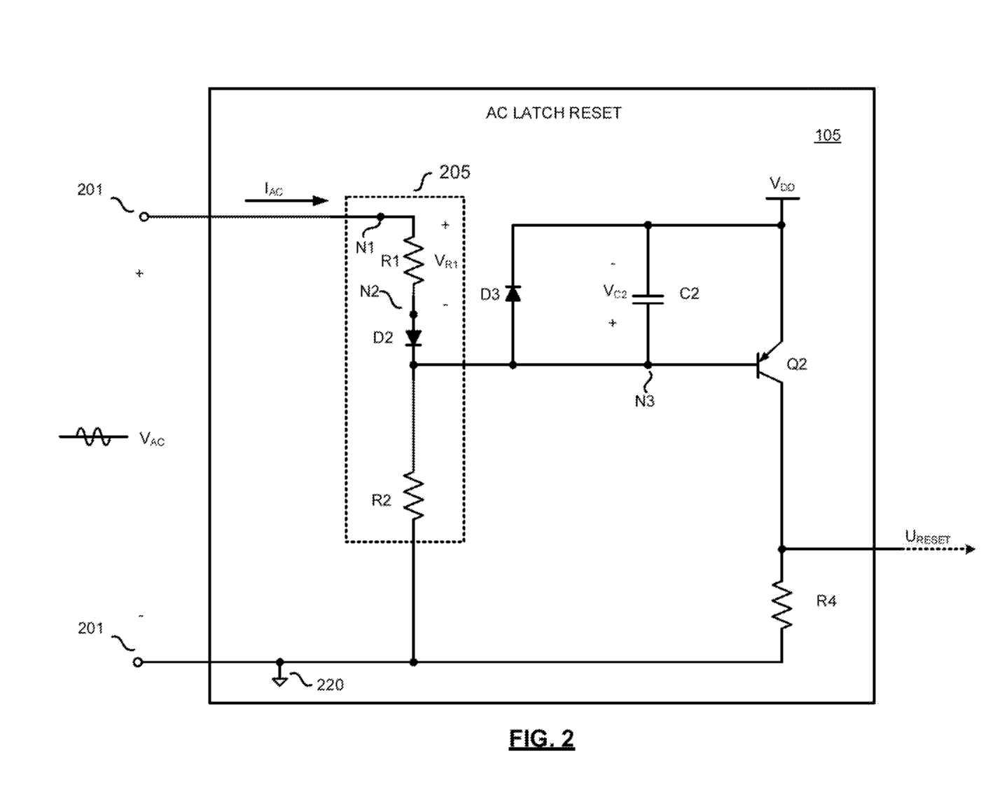

In some embodiments, power converter system 100 may further include a fault shutdown latch (not shown). This latch may be triggered during a system fault-condition, such as an over-voltage condition at the output, an under voltage condition at the output, or the like. Once a system fault-condition is detected, controller 107 may trigger the shutdown latch to prevent further switching of the power switch. In these embodiments, AC-latch-reset 105 may be used to reset the fault shutdown latch and thus restore normal device operation. For example, to reset the fault shutdown latch, the AC-latch-reset 105 may generate reset signal 117 in response to detecting a reset condition (e.g., removal of the ac input). Reset signal 117 may be received by controller 107, causing controller 107 to enter a normal operation mode in which it resets the fault shutdown latch, thereby allowing normal switching of the power switch. Various embodiments of AC-latch-reset 105 will be described in greater detail below with respect to FIGS. 2-7.

FIG. 2 illustrates a schematic diagram of an example AC-latch-reset 105 that may be used in power converter system 100. AC-latch-reset 105 receives input voltage V_{AC} at input terminals 201 and outputs a reset signal U_{RESET}. As will be described in greater detail below, while input voltage V_{AC} is received by AC-latch-reset 105 at an acceptable voltage, the voltage of reset signal U_{RESET} is equal to approximately 0 V (e.g., a voltage representing a logical low value). When input voltage V_{AC} is removed or is below an acceptable voltage level (representing a fault condition), the voltage of reset signal U_{RESET} is driven high to a voltage equal to a non-zero voltage (e.g., a voltage representing a logical high value) determined based at least in part on the values of V_{DD} and R4.

In some examples, reset signal U_{RESET} may be the same signal as reset signal 117 shown in FIG. 1. In these examples, reset signal U_{RESET} may be directly transmitted to controller 107. In other examples, reset signal U_{RESET} may be inverted (e.g., using one or more transistors configured as an inverter) before being transmitted to controller 107. In yet other examples, the reset signal U_{RESET} may be coupled to controller 107 over an isolated connection (e.g., an optocoupler or the like).

AC-latch-reset 105 of FIG. 2 may include a line detection capacitor C2 for detecting when input voltage V_{AC} is removed or is below an input voltage threshold for controller operation. During operation, line detection capacitor C2 is periodically charged during at least a portion of the time that input voltage V_{AC} is positive. The voltage at one end (node N3) of line detection capacitor C2 is monitored to determine if the voltage drops below a line detection threshold. A drop below the line detection threshold signals that input voltage V_{AC} has been removed or has dropped below an acceptable level for greater than an allowable period of time. The allowable period of time can be defined by values of capacitor C2 and resistor R2.

AC-latch-reset 105 may further include a high impedance circuit 205 coupled to the input terminals 201 of AC-latch-reset 105. In some embodiments, high impedance circuit 205 may include resistor R1, diode D2, and resistor R2. In this configuration, line detection capacitor C2 is charged through resistor R1 and diode D2 during at least a portion of each of the positive half-cycles of input voltage V_{AC}. Additionally, line detection capacitor C2 can be continuously discharged through resistor R2 during both the positive and negative half-cycles of input voltage V_{AC}. However, the rate of charge of capacitor C2 through resistor R1 and diode D2 during at least a portion of each of the positive half-cycles of input voltage V_{AC} may be greater than the rate of discharge of capacitor C2 through resistor R2, resulting in a net increase in charge on capacitor C2.

AC-latch-reset 105 may further include diode D3 coupled across line detection capacitor C2. Diode D3 can be included to limit the voltage V_{C2} across line detection capacitor C2 to a maximum value equal to the turn-on voltage of diode D3 (e.g., 0.7 V). Specifically, as the voltage V_{C2} across line detection capacitor C2 increases to the turn-on voltage of diode D3, diode D3 begins to conduct current from node N3 into voltage source V_{DD}, thereby preventing the voltage V_{C2} across line detection capacitor C2 from rising above a maximum value (the turn-on voltage of diode D3). By limiting the voltage V_{C2} across line detection capacitor C2, diode D3 also limits the voltage at node N3 to a maximum value approximately equal to the voltage of voltage source V_{DD} plus the turn-on voltage of diode D3 (e.g., about 0.7 V).

It can be desirable to limit the voltage V_{C2} across line detection capacitor C2 and the voltage at node N3 to provide a stable reference voltage from which capacitor C2 can be discharged. The stable reference voltage creates a constant, or at least substantially constant, discharge time between the maximum voltage of V_{C2} and a voltage level allowing the voltage at node N3 to drop below a threshold voltage that causes transistor Q2 to conduct. As a result, AC-latch-reset 105 may consistently generate reset signal U_{RESET} in response to removal of input voltage V_{AC} for longer than an allowable period of time or if the voltage of the ac input falls below an acceptable value.

As shown, AC-latch-reset 105 may further include PNP transistor Q2 to generate reset signal U_{RESET}. Specifically, transistor Q2 is shown coupled to voltage source V_{DD} and resistor R4. The state of transistor Q2 (e.g., ON/OFF), which is determined at least in part on the voltage at node N3, dictates the amount of current allowed to pass through resistor R4, and thus, the voltage of reset signal U_{RESET}.

AC-latch-reset 105 may be configured such that when input V_{AC} is applied to AC-latch-reset 105, the voltage at node N3 is large enough such that the voltage difference between the base and emitter of transistor Q2 may be below the turn-on threshold voltage of PNP transistor Q2, thus preventing current from being conducted through the transistor Q2 and resistor R4. As a result, the voltage of reset signal U_{RESET} remains at or near the reference voltage of output return 220.

Additionally, AC-latch-reset 105 may be further configured such that when input voltage V_{AC} is disconnected from AC-latch-reset 105 or when input voltage V_{AC} falls below an input voltage threshold, the voltage at node N3 drops below a line detection threshold voltage, causing the voltage difference between the base and emitter of transistor Q2 to rise above the turn-on threshold voltage of transistor Q2, allowing current to conduct through transistor Q2 and resistor R4. As a result, the voltage of reset signal U_{RESET} rises to a voltage that is a function of the current passing through transistor Q2 and the resistance of resistor R4. Since transistor Q2 is inactive during normal operation and only active for a brief time during a fault condition, when the voltage at node N3 drops below a certain line detection threshold, power consumption of transistor Q2 is reduced.

In some embodiments, the base to emitter breakdown voltage of transistor Q2 can be 5V or less. In these embodiments, to prevent transistor Q2 from failing, the voltage at node N3 can be clamped to a voltage that is less than the voltage of V_{DD} plus the base to emitter breakdown voltage of transistor Q2. For example, as shown in FIG. 2, node N3 can be clamped to the same voltage source V_{DD} that is coupled to the emitter of transistor Q2.

AC-latch-reset 105 may further include a base resistor (not shown) coupled to the base of transistor Q2. In one example, the base resistor may form a resistor divider with resistor R2 and may set a minimum voltage across capacitor C2.

Given the description above, it should be apparent that many variations of values for each component may be used to provide the desired performance for any given application. However, in one example embodiment, the components may have approximately the following values: R1=10 MΩ R2=10 MΩ, R4=100 kΩ, V_{DD}=5.8 V, C2=22 nF, β of Q2=20, and the breakdown voltage of D2 and D3=75 V. In some examples, this particular configuration allows the circuit to detect the presence of an ac input having a voltage of 40 VAC or greater while consuming a relatively small amount of power.

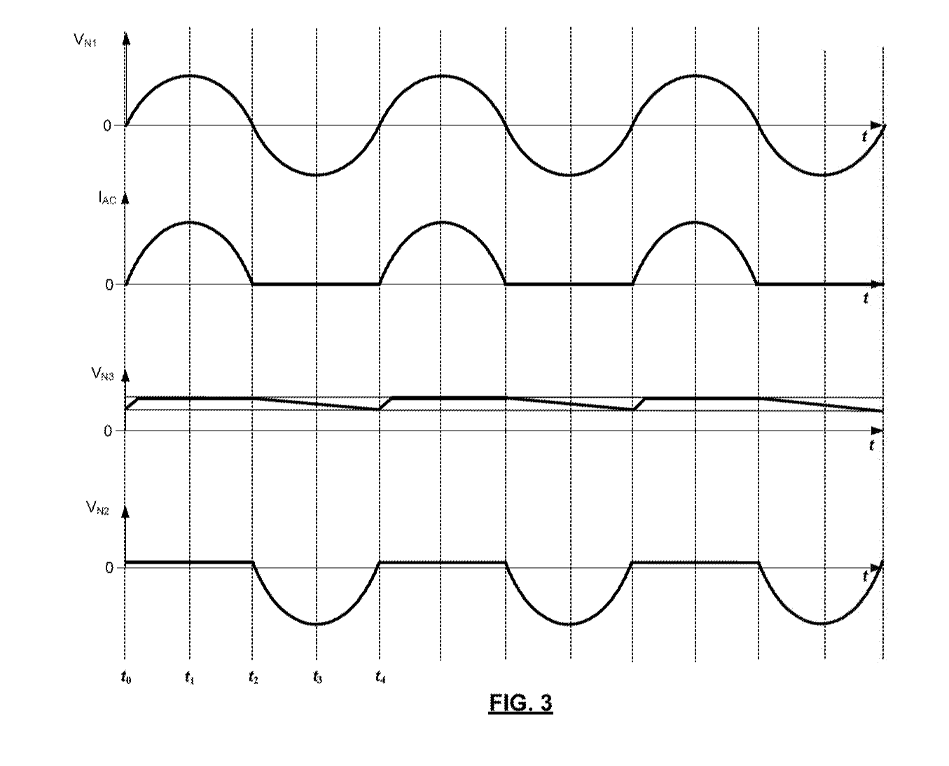

The operation of AC-latch-reset 105 will now be described with simultaneous reference to the schematic of AC-latch-reset 105 shown in FIG. 2 and the example waveforms shown in FIG. 3. When applied to input terminals 201 of AC-latch-reset 105, input voltage V_{AC} causes a sinusoidal voltage V_{N1} to appear at node N1. As can be seen in FIG. 3, voltage V_{N2} at node N2 is clamped to a maximum value during the positive half-cycles of input voltage V_{AC} (represented by the voltage V_{N1} at node N1) but has a linear relationship with input voltage V_{AC} during the negative half-cycles of input voltage V_{AC}. Specifically, as input voltage V_{AC} increases from zero volts (e.g., at time t₀), the voltage V_{N2} at node N2 follows the input voltage V_{AC} until reaching a maximum value approximately equal to the voltage of V_{DD} plus the turn-on voltage of diode D2 and diode D3 (the increase in V_{N2} to the maximum value is not shown due to the relatively short period of time required for V_{N2} to reach this value). Once input voltage V_{AC} (and thus, voltage V_{N2} at node N2) reaches this value, diode D2 may begin to conduct current. As a result, diode D2 clamps the voltage V_{N2} at node N2 to the voltage of node N3, which itself is clamped to voltage source V_{DD} by diode D3. As a result, as shown in FIG. 3, the voltage V_{N2} at node N2 is relatively constant for most of the positive half-cycle of input voltage V_{AC}. During the negative half-cycle of input voltage V_{AC} (e.g., between time t₂ and t₄), however, the input voltage V_{AC} causes the voltage V_{N2} at node N2 to be lower than the voltage of V_{DD} plus the turn-on voltage of diode D2. As a result, diode D2 does not conduct, and the voltage V_{N2} at node N2 substantially follows the voltage of input voltage V_{AC}.

Referring now to input current I_{AC} shown in FIG. 3, current I_{AC} has a substantially linear relationship with input voltage V_{AC} during positive half-cycles of input voltage V_{AC} (e.g., between time t₀ and t₂) and has a value substantially equal to zero during negative half-cycles of input voltage V_{AC} (e.g., between time t₂ and t₄). Specifically, during positive half-cycles of input voltage V_{AC}, as described above, the voltage V_{N2} at node N2 remains substantially constant while the voltage V_{N1} at node N1 changes sinusoidally. As a result, a potential difference that changes linearly with input voltage V_{AC} is generated across resistor R1, creating a current that also changes linearly with input voltage V_{AC}. During negative half-cycles of input voltage V_{AC} (e.g., between time t₂ and t₄), as described above, diode D2 does not conduct, resulting in substantially no current being conducted through resistor R1. Thus, the value of I_{AC} during negative half-cycles of input voltage V_{AC} is substantially equal to zero.

Referring now to voltage V_{N3} at node N3 shown in FIG. 3, voltage at V_{N3} remains relatively constant while input voltage V_{AC} is applied to input terminals 201 of AC-latch-reset 105. Specifically, while current I_{AC} has a positive value (while diode D2 is conducting), the voltage V_{N3} at node N3 can increase as capacitor C2 is being charged until reaching a maximum value approximately equal to the voltage of V_{DD} plus the turn-on voltage of diode D3. While current I_{AC} has a value substantially equal to zero (while diode D2 is not conducting), the voltage V_{N3} at node N3 begins to drop as capacitor C2 is discharged through resistor R2. The minimum voltage of V_{N3} of node N3 during normal operation can be set to be greater than the voltage of voltage source V_{DD} minus the turn-on voltage of transistor Q2 to prevent transistor Q2 from being turned ON. The minimum voltage V_{N3} of node N3 during normal operation may be determined based at least in part on the RC time constant created by capacitor C2 and resistor R2.

Referring back to FIG. 2, it should be appreciated that if input voltage V_{AC} is removed from the input terminals 201 of AC-latch-reset 105, the voltage V_{N3} at node N3 would continue to fall, eventually falling below a voltage level that causes transistor Q2 to conduct. As a result, current will be conducted through resistor R4, thereby causing U_{RESET} to rise to non-zero voltage level or a voltage level corresponding to a logical high value (voltage based on current conducted through transistor Q2 and resistance of R4). Similarly, if input voltage V_{AC} is below an acceptable value, the voltage of V_{N3} will drop below a voltage level that causes transistor Q2 to conduct, thereby causing U_{RESET} to rise to a voltage corresponding to a logical high value.

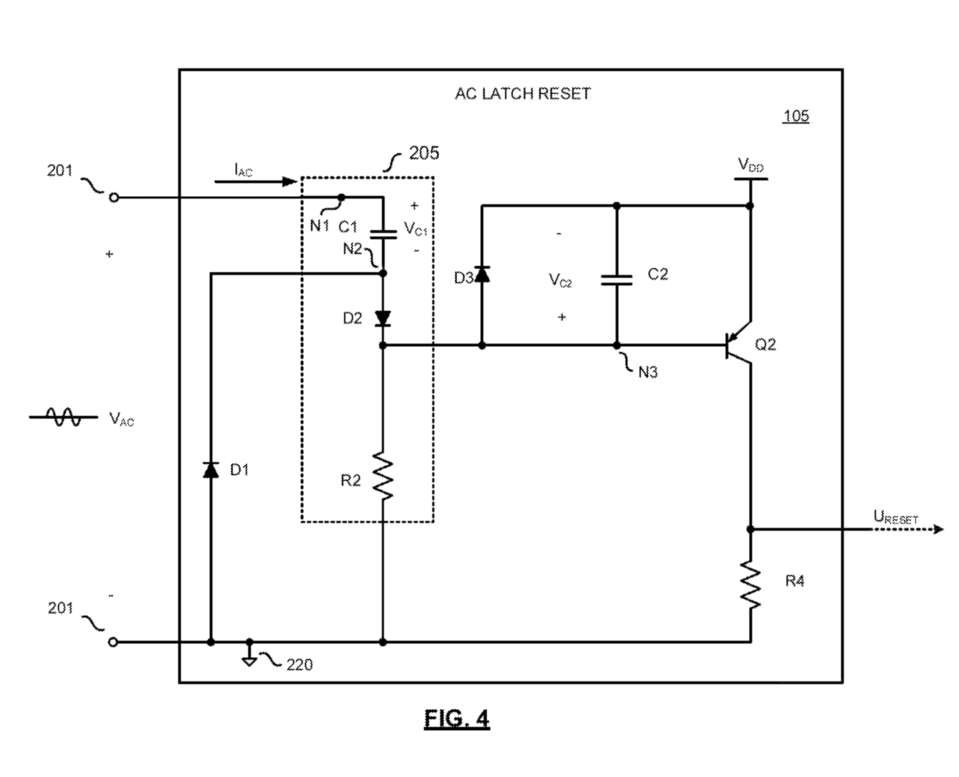

FIG. 4 illustrates a schematic diagram of another example AC-latch-reset 105 that may be used in power converter system 100. AC-latch-reset 105 shown in FIG. 4 is similar to AC-latch-reset 105 shown in FIG. 2, however, resistor R1 is replaced with capacitor C1 and diode D1 is coupled across diode D2 and resistor R2. Diode D1 can be included to clamp the voltage V_{N2} at node N2 to output return 220. Capacitor C1 can be included to reduce the amount of power consumed by high-impedance circuit 205 since power dissipated by capacitor C1 will be read as reactive power on a watt meter. While many variations of values for each component of AC-latch-reset may be used to provide the desired performance for any given application, in one example embodiment, the components may have approximately the following values: C1=150 pF, R2=10_MΩ, R4=100 kΩ, V_{DD}=5.8 V, C2=22 nF, β of Q2=20, and the breakdown voltage of diodes D1, D2, and D3=75 V. In some examples, this particular configuration allows the circuit to detect the presence of an ac input having a voltage of 40 VAC or greater while consuming a relatively small amount of power.

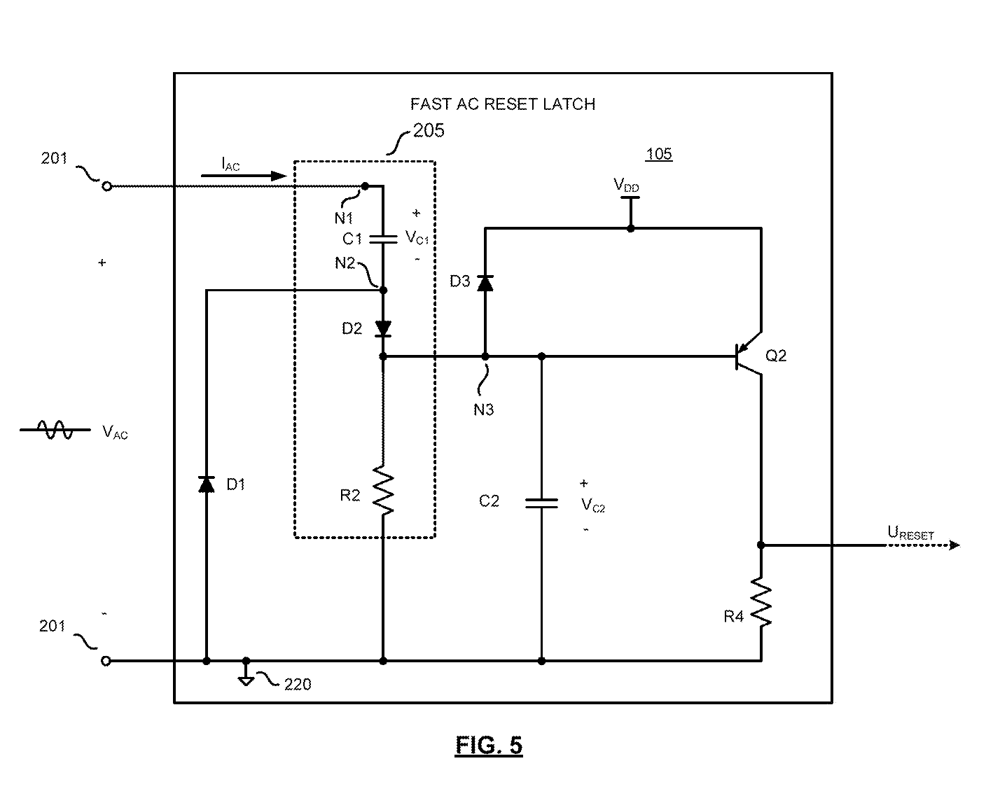

FIG. 5 illustrates a schematic diagram of another example AC-latch-reset 105 that may be used in power converter system 100. AC-latch-reset 105 shown in FIG. 5 is similar to AC-latch-reset 105 shown in FIG. 4, however, capacitor C1 can be coupled to output return 220 rather than voltage source V_{DD}. While many variations of values for each component of AC-latch-reset may be used to provide the desired performance for any given application, in one example embodiment, the components may have approximately the following values: C1=150 pF, R2=10 MΩ, R4=100 kΩ, V_{DD}=5.8 V, C2=22 nF, β of Q2=20, and the breakdown voltage of diodes D1, D2, and D3=75 V. In some examples, this particular configuration allows the circuit to detect the presence of an ac input having a voltage of 40 VAC or greater while consuming a relatively small amount of power.

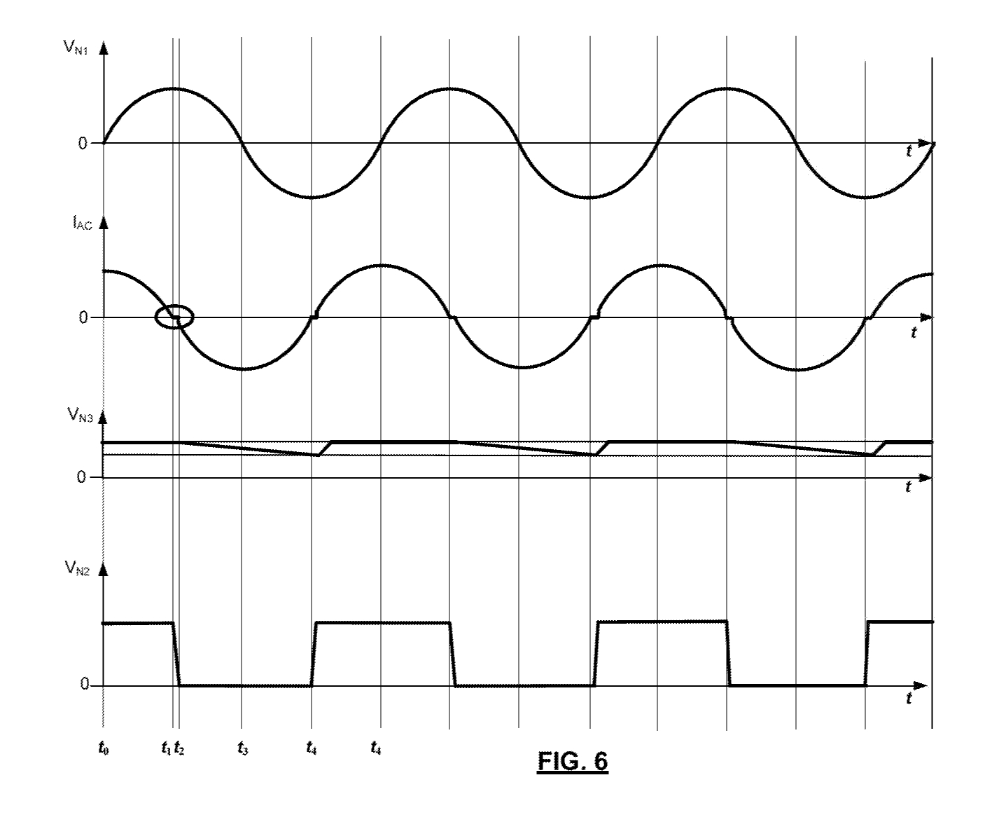

The operation of the embodiments of AC-latch-reset 105 shown in FIGS. 4 and 5 are similar and will be described with reference to the waveforms shown in FIG. 6. When applied to input terminals 201 of AC-latch-reset 105, input voltage V_{AC} causes a sinusoidal voltage V_{N1} to appear at node N1. The input current I_{AC} generally has a linear relationship with input voltage V_{AC}, but is 90 degrees out of phase with input voltage V_{AC} and includes brief interruptions in its otherwise sinusoidal waveform. These interruptions are caused by brief periods of time (e.g., between time t₁ and t₂) where both diode D1 and D2 are not conducting. As shown in FIG. 6, voltage V_{N2} at node N2 remains relatively constant at a maximum value as input voltage V_{AC} increases from zero volts to its peak value (between time t₀ and t₁). This maximum value represents the voltage required to cause diode D2 to conduct, which is approximately equal to the voltage V_{N3} at node N3 (equal to approximately the voltage of voltage source V_{DD} plus the turn-on voltage of diode D3 during normal operation) plus the turn-on voltage of diode D2. At the peak value of input voltage V_{AC} (at time t₁) and as V_{AC} begins to decrease, the voltage V_{N2} at node N2 quickly drops (between time t1 and t2) to a minimum value. This decrease is caused by the voltage of V_{AC} decreasing faster than capacitor C1 dissipates its charge, resulting in the voltage at node N2 being forced to a lower value until reaching its minimum value caused by node N2 being clamped to the voltage of output return 220 by diode D1. The minimum value can be approximately equal to the voltage of output return 220 minus the turn-on voltage of D1. Once voltage V_{N2} at node N2 drops to its minimum value representing the voltage at which diode D1 begins to conduct, current I_{AC} can begin to conduct through diode D1 and capacitor C1. As a result, current I_{AC} is allowed to conduct and generally has a linear relationship with input voltage V_{AC}, but has a 90 degree phase shift relative to input voltage V_{AC}.

Referring now to voltage V_{N3} at node N3 shown in FIG. 6, voltage V_{N3} at remains relatively constant while input voltage V_{AC} is applied to input terminals 201 of AC-latch-reset 105. Specifically, periods of time where current I_{AC} has a positive value (while diode D2 is conducting), the voltage V_{N3} at node N3 can increase as capacitor C2 is charged until reaching a maximum value approximately equal to the voltage of V_{DD} plus the turn-on voltage of diode D3. During periods of time where current I_{AC} has a value substantially equal to zero or while current I_{AC} has a negative value (while diode D2 is not conducting), the voltage V_{N3} at node N3 decreases as capacitor C2 is discharged through resistor R2. The minimum voltage of V_{N3} of node N3 during normal operation can be set to be greater than the voltage at which transistor Q2 begins to conduct current. The minimum voltage V_{N3} of node N3 during normal operation may be determined based at least in part on the RC time constant created by capacitor C2 and resistor R2.

Referring back to FIGS. 4 and 5, it should be appreciated that if input voltage V_{AC} is removed from the input terminals 201 of AC-latch-reset 105, the voltage V_{N3} at node N3 would continue to decrease, eventually falling below the voltage at which transistor Q2 begins to conduct current. As a result, current will be conducted through resistor R4, thereby causing U_{RESET} to rise to non-zero voltage level or a voltage level corresponding to a logical high value (voltage based on current conducted through transistor Q2 and resistance of R4). Similarly, if input voltage V_{AC} is below an acceptable value, the voltage of V_{N3} will drop below a voltage level that causes transistor Q2 to conduct, thereby causing U_{RESET} to rise to a voltage corresponding to a logical high value.

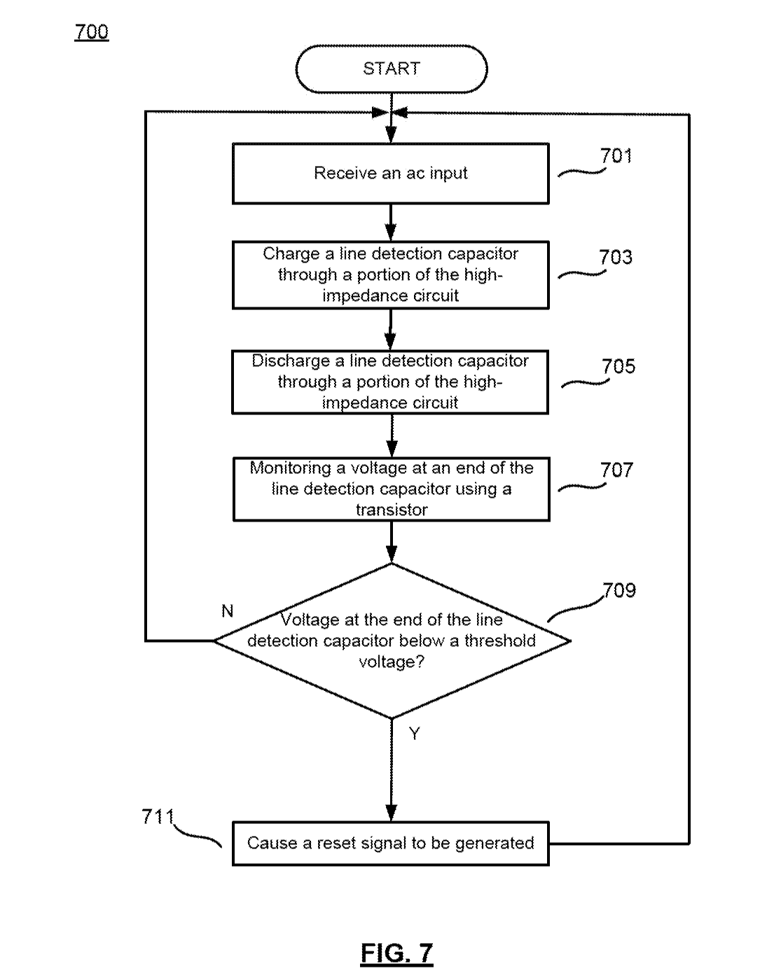

Referring now to FIG. 7, an example process 700 for detecting a fault condition in the ac input of a power converter is shown. At block 701 of process 700, an ac input may be received at a high-impedance circuit. The high-impedance circuit may be similar to high-impedance circuit 205 of FIG. 2, 4, or 5, and may include an impedance element, diode, and a resistor. For example, in some embodiments, the high-impedance circuit may include a first resistor, a diode, and a second resistor. In other embodiments, the high-impedance circuit may include a capacitor, a diode, and a resistor.

At block 703, a line detection capacitor may be charged through the high impedance circuit. This may occur while the diode of the high-impedance circuit is conducting. In some embodiments, the line detection capacitor may be similar to capacitor C2, and may be charged through capacitor C1 and diode D2 of high impedance circuit 205 while diode D2 is conducting. In other embodiments, the line detection capacitor may be similar to capacitor C2, and may be charged through resistor R1 and diode D2 of high impedance circuit 205 while diode D2 is conducting.

At block 705, the voltage across the line detection capacitor may decrease as the line detection capacitor is discharged through the resistor of the high-impedance circuit. This may occur while the diode of the high-impedance circuit is not conducting. For example, line detection capacitor C2 may be discharged through resistor R2 of high impedance circuit 205 while no current is conducting through diode D2.

At block 707 the voltage at one end of line detection capacitor may be monitored. For example, transistor Q2 may be used to monitor the voltage at node N3 coupled to line detection capacitor C2. At block 709, it may be determined whether or not the voltage at one end of line detection capacitor has fallen below a threshold voltage. If the voltage is not below the threshold voltage, the process returns to block 701. However, if the voltage is below the threshold voltage, the process moves to block 711. For example, transistor Q2 may be used to facilitate monitoring of the voltage at node N3 coupled to line detection capacitor C2 to determine whether or not the at node N3 has fallen below a line detection threshold voltage. In the examples shown in FIGS. 2, 4, and 5, the line detection threshold voltage may be equal to or less than the voltage of voltage source V_{DD} minus the emitter-base voltage of transistor Q2.

At block 711, a reset signal may be generated. For example, if the voltage V_{N3} at node N3 falls below the line detection threshold voltage, transistor Q2 may turn on, driving the voltage of reset signal U_{RESET} to a non-zero voltage representing a high signal.

While the blocks of process 700 have been presented in a particular sequence, it should be appreciated that they may be performed in any order and that one or more blocks may be performed at the same time. For instance, a transistor (e.g., transistor Q2) may be used to facilitate the monitoring of the voltage at one end of line detection capacitor C2 as the input voltage V_{AC} causes the capacitor to be repeatedly charged and discharged. In one example, if the ac input is removed, the transistor may monitor the voltage at one end of line detection capacitor C2 as the capacitor is discharged. Upon reaching the turn-on threshold voltage, transistor Q2 may turn on, causing reset signal U_{RESET} to be generated.

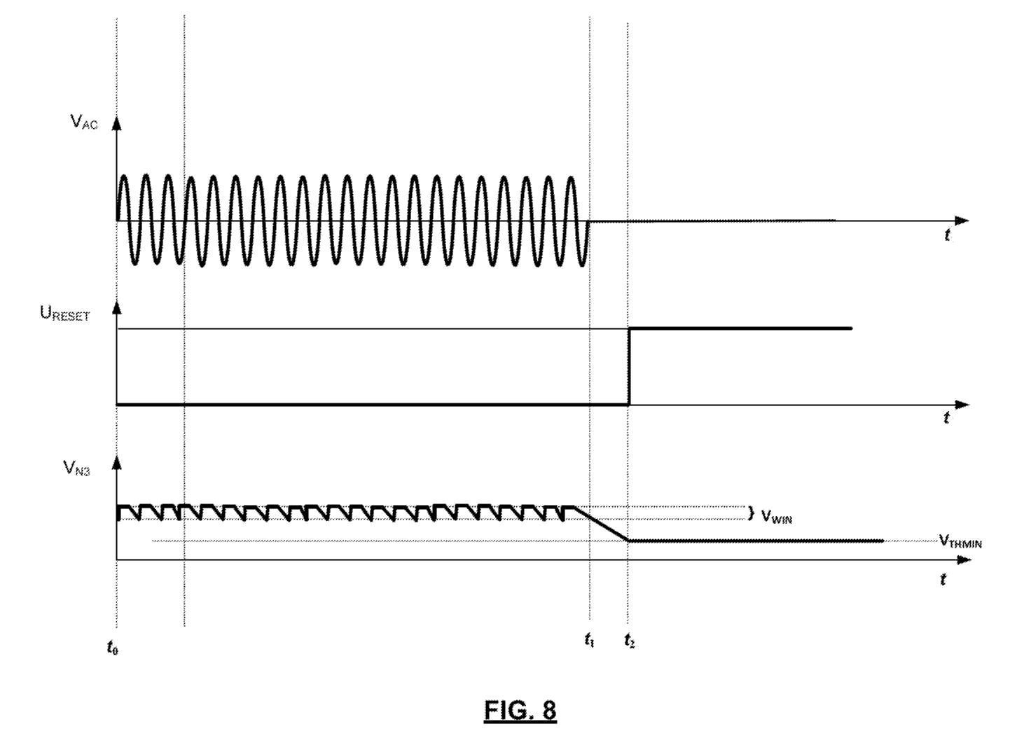

FIG. 8 further illustrates example waveforms of fast ac-reset latch in FIG. 2. Specifically, several cycles of ac input voltage V_{AC} are shown in relation to reset signal U_{RESET} and a waveform of node voltage V_{N3}. Between time t₀ and t₁, during normal operation, ac input V_{AC} is provided at input terminals 201 and reset signal U_{RESET} is set low. In addition, voltage at node V_{N3} varies within a voltage window V_{WIN}. Specifically, during time t₀ and t₁, voltage at node V_{N3} varies between a minimum voltage based in part on values of resistor R2, capacitor C2, and the line frequency, and a maximum voltage of substantially V_{DD} V_{D3}. At time t₁, ac input voltage V_{AC} is removed and is no longer provided to input terminals 201 which causes node voltage V_{N3} to drop. As shown, node voltage V_{N3} continues to drop until the voltage drops below a minimum threshold value V_{THMIN}. At time t₂, when node voltage V_{N3} approaches V_{THMIN}, reset signal U_{RESET} transitions to a logic high, indicating that voltage provided at the input terminals has been reduced below a threshold value. In this manner, fast ac reset latch indicates to controller that ac input voltage has been removed from input terminals 201. In one example, the reset signal may trigger a controller of a power converter to reset any latched conditions that may have been triggered.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

1. A latch-reset for detecting a fault condition in an alternating current (ac) input voltage, the latch-reset comprising:
a high-impedance circuit comprising an impedance element, a first diode, and a first resistor;
a line detection capacitor coupled to the high-impedance circuit, wherein the line detection capacitor is configured to be charged by the ac input voltage through the impedance element and the first diode while the first diode is conducting, and wherein the line detection capacitor is configured to be discharged through the first resistor while the first diode is not conducting; and
a transistor, wherein the transistor is configured to switch in response to a voltage at an end of the line detection capacitor dropping below a line detection threshold voltage, and wherein the transistor is further configured to cause a reset-signal to be generated in response to the transistor being switched.

2. The latch-reset of claim 1 further comprising a second diode coupled to a voltage source and a base of the transistor.

3. The latch-reset of claim 2, wherein the line detection threshold voltage is equal to or less than a voltage of the voltage source minus a turn-on threshold voltage of the transistor.

4. The latch-reset of claim 3, wherein the voltage at the end of the line detection capacitor is between the line detection threshold voltage and the voltage of the voltage source plus a turn-on voltage of the second diode during normal operation.

5. The latch-reset of claim 1, wherein the fault condition comprises the ac input voltage being disconnected from a power converter system.

6. The latch-reset of claim 1, wherein the fault condition comprises an under-voltage condition in the AC input voltage.

7. The latch-reset of claim 1, wherein the transistor is a PNP transistor.

8. A latch-reset for detecting a fault condition in an alternating current (ac) input voltage, the latch-reset comprising:
an impedance element coupled to receive the ac input voltage; and
a transistor, wherein the transistor is configured to switch in response to the ac input voltage dropping below an input voltage threshold, and wherein the transistor is further configured to cause a reset-signal to be generated when the transistor is switched.

9. The latch-reset of claim 8, wherein the transistor is a PNP transistor.

10. The latch-reset of claim 8 further comprising a line detection capacitor coupled to the transistor, wherein the transistor switches in response to a voltage at an end of the line detection capacitor decreasing below a line detection threshold voltage, and wherein the voltage at the end of the line detection capacitor decreases below the line detection threshold voltage in response to the ac input voltage dropping below the input voltage threshold.

11. The latch-reset of claim 8, wherein the latch-reset further comprises a diode coupled to a voltage source and a base of the transistor.

12. The latch-reset of claim 11, wherein the line detection threshold voltage is equal to or less than a voltage of the voltage source minus a turn-on threshold voltage of the transistor.

13. The latch-reset of claim 12, wherein the voltage at the end of the line detection capacitor is between the line detection threshold voltage and the voltage of the voltage source plus a turn-on voltage of the diode during normal operation.

14. The latch-reset of claim 8, wherein the impedance element comprises a resistor or a capacitor.

15. A method for detecting a fault condition in an alternating current (ac) input voltage, the method comprising:
receiving the ac input voltage at a high-impedance circuit, the high-impedance circuit comprising an impedance element, a first diode, and a first resistor;
charging, using the ac input voltage, a line detection capacitor through the impedance element and the first diode, wherein the line detection capacitor is charged while the first diode is conducting;
discharging the line detection capacitor through the first resistor, wherein the line detection capacitor is discharged while the first diode is not conducting;
monitoring a voltage at an end of the line detection capacitor using a transistor, wherein the transistor is configured to switch in response to a voltage at the end of the line detection capacitor dropping below a line detection threshold voltage; and
causing a reset-signal to be generated in response to the transistor being switched.

16. The method of claim 15, wherein the high-impedance circuit further comprises a second diode coupled to a voltage source and a base of the transistor.

17. The method of claim 16, wherein the line detection threshold voltage is equal to or less than a voltage of the voltage source minus a turn-on threshold voltage of the transistor.

18. The method of claim 17, wherein the voltage at the end of the line detection capacitor is between the line detection threshold voltage and the voltage of the voltage source plus a turn-on voltage of the second diode during normal operation.

19. The method of claim 15, wherein the fault condition comprises the ac input voltage being disconnected from a power converter system.

20. The method of claim 15, wherein the fault condition comprises an under-voltage condition in the ac input voltage.

21. The method of claim 15, wherein the transistor is a PNP transistor.

22. A power converter system, comprising:
an ac bridge coupled to receive an ac input voltage and coupled to output a time-varying dc voltage;
a power converter coupled to the ac bridge and coupled to receive the time varying dc voltage and to output a regulated dc output voltage;
a controller coupled to the power converter and coupled to control the transfer of energy through the power converter; and
a latch-reset coupled to receive the ac input voltage and coupled to output a reset signal to the controller in response to the ac input voltage dropping below an input voltage threshold, wherein the latch-reset comprises a high impedance element coupled to receive the ac input voltage.

23. The power converter of claim 22, wherein the latch-reset further comprises:
a line detection capacitor, wherein a voltage at an end of the line detection capacitor decreases below a line detection threshold voltage in response to the ac input voltage dropping below the input voltage threshold; and
a transistor, wherein the transistor is configured to switch when the voltage at the end of the line detection capacitor decreases below the line detection threshold, and wherein the transistor is further configured to cause the reset-signal to be generated when the transistor is switched.

24. The power converter of claim 23, wherein the latch-reset further comprises a diode coupled to a voltage source.

25. The power converter of claim 24, wherein the line detection threshold voltage is equal to or less than a voltage of the voltage source minus a turn-on threshold voltage of the transistor.

26. The power converter of claim 25, wherein the voltage at the end of the line detection capacitor is between the line detection threshold and the voltage of the voltage source plus a turn-on voltage of the diode during normal operation.

27. The power converter of claim 22, wherein the transistor is a PNP transistor.
